(19) United States
(12) Patent Application Publication
(10) Pub. No.: US 2022/0090704 A1
(43) Pub. Date: Mar. 24, 2022

(54) MID-STREAM BRACKET

(71) Applicant: 3D & L, LLC, West Plains, MO (US)

(72) Inventors: Douglas Harris, Cape Fair, MO (US); Logan Harris, Cape Fair, MO (US)

(21) Appl. No.: 17/481,387

(22) Filed: Sep. 22, 2021

Related U.S. Application Data
(60) Provisional application No. 63/082,260, filed on Sep. 23, 2020.

(51) Int. Cl. F16L 3/10

(52) U.S. Cl. CPC F16L 3/1091

(57) ABSTRACT

A bracket to support a drainpipe in relation to a structure, or water lines in relation to a drainpipe. The device may comprise a semi-cylindrical collar with a gap for positioning around a drainpipe that is already installed in a structure without a free end available. A second semi-cylindrical collar member is attachable in the gap in the first collar. The collars may be provided with arms having apertures for supporting water lines. The arms may also be used to attach the bracket to framing or other parts of the building structure.

### CROSS-REFERENCE TO RELATED APPLICATIONS

This application claims the benefit of U.S. Provisional Patent Application Ser. No. 63/082,260 filed on Sep. 23, 2020, the disclosure of which is incorporated herein by reference.

### BACKGROUND

### Field of the Invention

This disclosure is in the field of plumbing fixtures. More specifically, the disclosure is in the field of brackets for supporting water lines and drainpipes with relation to each other and a building structure.

### Description of the Related Art

Many common plumbing installations require more than one pipe or line to be routed in substantially the same direction. For example, it is often desired to run a hot water pipe, a cold water pipe, and a drain pipe substantially in parallel to one another to a sink, a tub, a shower, or other similar fixtures in a building. Attaching each pipe or line to the structure or otherwise providing support to each pipe individually is time consuming and may be impractical depending on the location of studs or other structural members to which a pipe may be secured in a wall. In other situations, such as repairs or retrofitting of plumbing it may not be possible to access nearby structural members of the wall to attach a pipe to it.

In some cases, brackets may be attached to a large pipe, often a drain pipe, to support smaller pipes such as water lines. These brackets may require access to the end of the support pipe so they may only be used during new construction when the user is able to plan ahead and install the bracket during rough in before it is needed to support the water pipes. Often this is not possible, and so it would be desirable to be able to attach a support bracket to a pipe such as a drain pipe, after it has already been installed into the plumbing of the structure. This is desirable in new construction and retrofitting and repair situations.

### SUMMARY OF THE INVENTION

In various embodiments, the device supports a drainpipe. In some embodiments the device comprising a first semi-cylindrical collar member having a gap, a second semi-cylindrical collar member for disposition in the gap in the first collar member, retention channels on the first collar member for receiving retention members on the second collar member, the retention channels receiving the retention members for holding the second collar member in the gap in the first collar member. The device may also have arms for support water lines or other plumbing lines in relation to the bracket and the drainpipe.

### BRIEF DESCRIPTION OF THE DRAWINGS

FIG. 1A is a perspective view of an embodiment of a portion of the bracket.

FIG. 1B is a perspective view of an embodiment of a portion of the bracket.

FIG. 1C is a top view of an embodiment of a portion of the bracket.

FIG. 1D is a bottom view of an embodiment of a portion of the bracket.

FIG. 1E is a side view of an embodiment of a portion of the bracket.

FIG. 1F is a side view of an embodiment of a portion of the bracket.

FIG. 1G is a side view of an embodiment of a portion of the bracket.

FIG. 1H is a cross-sectional detail view of an embodiment of a portion of the bracket along the axis H-H shown in FIG. 1D.

FIG. 1I is a cross-sectional detail view of an embodiment of a portion of the bracket along the axis I-I shown in FIG. 1D.

FIG. 2A is a perspective view of an embodiment of a second portion of the bracket.

FIG. 2B is a side view of an embodiment of a second portion of the bracket.

FIG. 2C is a side view of an embodiment of a second portion of the bracket.

FIG. 2D is a top view of an embodiment of a second portion of the bracket.

FIG. 2E is a bottom view of an embodiment of a second portion of the bracket.

FIG. 3A is a perspective view of an embodiment of the bracket in a partially closed configuration.

FIG. 3B is a perspective view of an embodiment of the bracket in a closed position.

### DETAILED DESCRIPTION

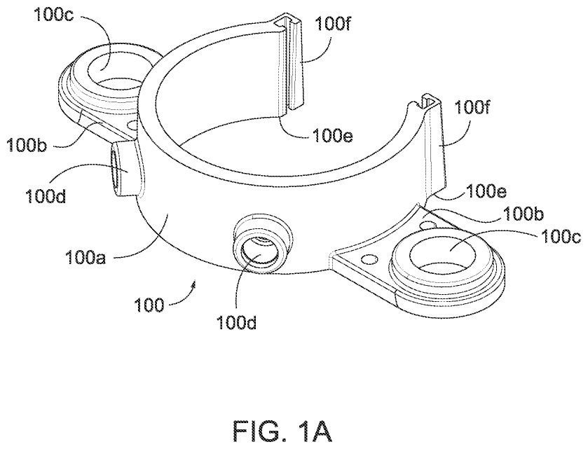

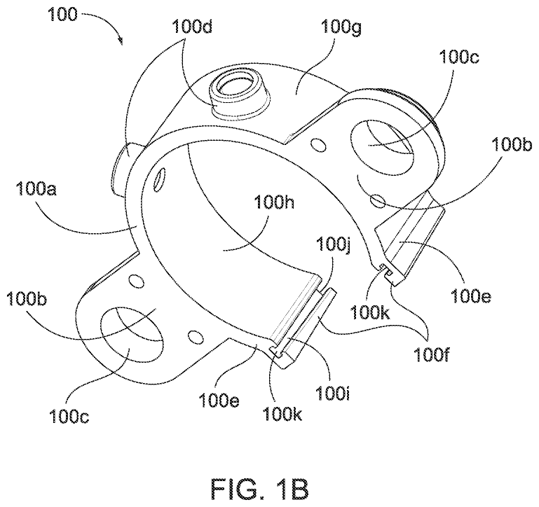

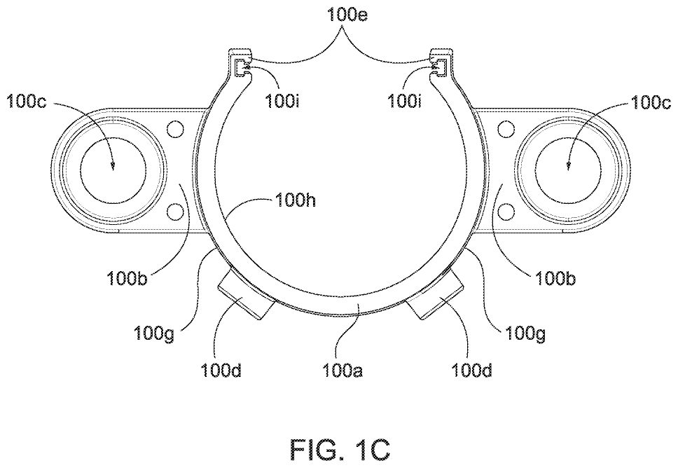

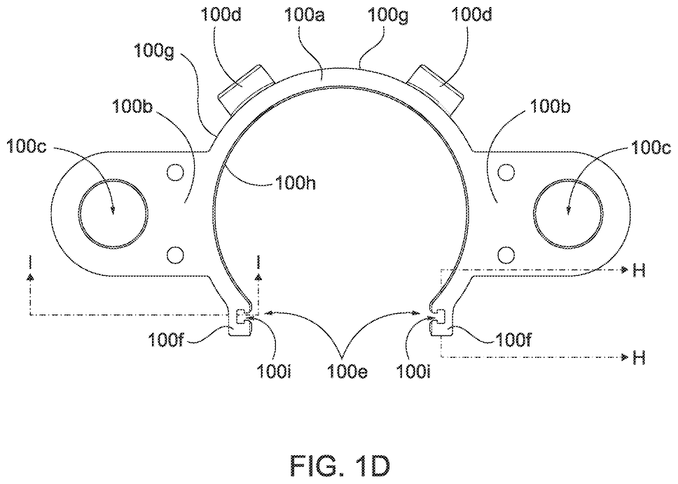

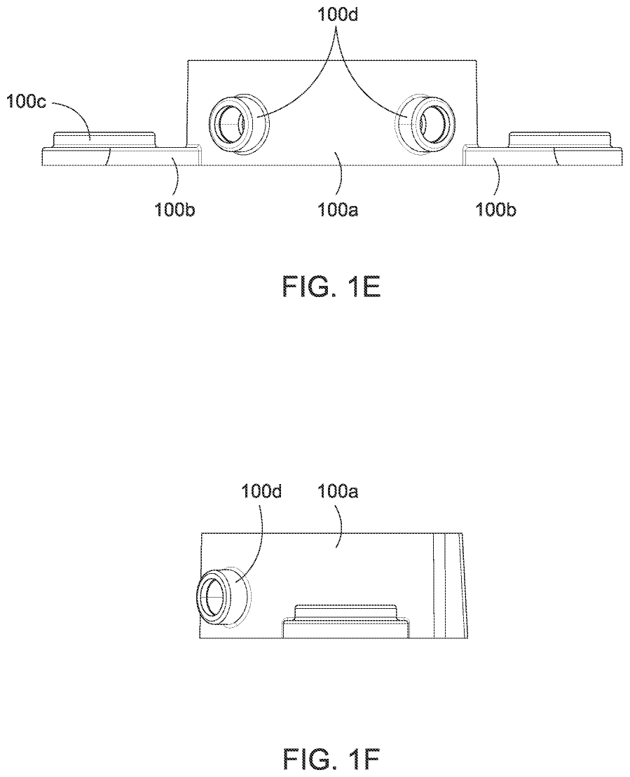

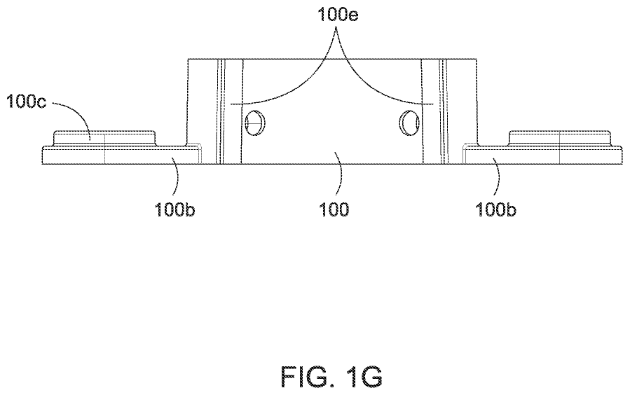

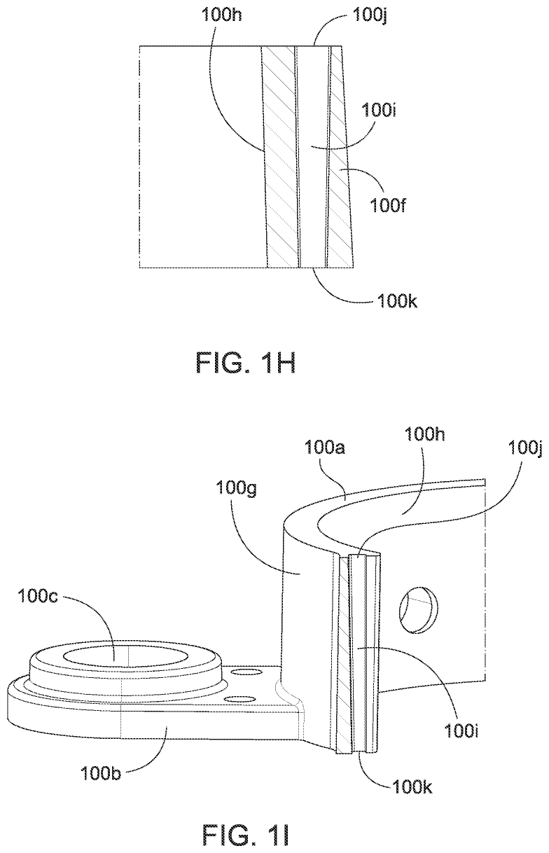

Referring now to FIGS. 1A through 1I, an embodiment of a portion of the inventive device is depicted. The depicted embodiment of the support bracket portion 100 of the device comprises a collar 102a that has two spaced apart ends that define a gap. The gap allows the collar to be attached around a pipe that has already been installed into a structure. The material of the collar 100a may be flexible so that the collar 100a can flex to widen the gap enough to let it pass around the diameter of a pipe. In some embodiments the gap may be wide enough that the collar 100a does not need to flex to pass around the pipe. In such cases the collar 100a may encompass approximately half of the circumference of the pipe.

The collar 100a may provide support for one or more arms, tabs, or support members 100b for receiving and supporting other pipes or lines in relationship to the pipe to which the inventive bracket is attached. In the depicted embodiment there are two arms 102b, each with one aperture 100c for receiving a water line or other conduit, line, wire, or pipe. In other embodiments, there may be only one arm 100b or more than two arms 100b. The arms 102b may be provided with screw or bolt holes or other fasteners to allow the arms to be attached to studs, subfloors, or other framing or structural elements of a building structure to hold the drain and supply lines in place with respect to the structure, vertically, horizontally, or both.

In other embodiments, the arms 100b may have more than one aperture 100c and may have different numbers of apertures 100c in each arm 100b. In some embodiments the apertures 100c may not be completely enclosed, but may have gaps to allow a water line or other pipe to be snapped into place without feeding an end of the line or pipe into the aperture 100c.

In the depicted embodiment, the collar 100a is provided with two optional fastening mechanisms 100d. In the depicted embodiment, these fastening mechanisms 100d comprise a threaded aperture through collar 100a for receiving a set screw to engage the outer surface of the pipe on which the inventive bracket is installed. This allows the collar 100a to be held in relationship to a specific location on the support pipe without sliding. The fastening mechanism may comprise any number of fastening mechanisms 100d, or none. In some embodiments, an adhesive may be used to hold the collar 100a in place on the support pipe. In other embodiments the collar 100a may be held in place by friction between the collar 100a and the support pipe. In varying embodiments, the fastening mechanisms may be engaged to hold the collar 100a in place either before or after the connection member 102 described below is attached to the bracket 100.

The collar 100a extends to two ends 100e defining the gap for positioning the collar 100a around a support pipe. At least one, and preferably both, ends of the collar 100a are provided with a fastening mechanism for releasably connecting the collar 100a to a connector member 102 that completes the closure of the inventive bracket around the circumference of the support pipe. In the depicted embodiment of the bracket, the fastening mechanism comprises a retention channel 100i disposed in a flange 100f extending outwardly from each end 100e of collar 100a.

In the depicted embodiment the retention channel 100i comprises a substantially T-shaped channel extending from the top edge of the flange 100f to the bottom edge of the flange 100f. In some embodiments the retention channel 100i may extend only partially downward from the top edge of flange 100f, or only partially upward from the bottom edge of flange 100f. In this embodiment some of the dimensions of the channel 100i decrease as the channel progresses downwardly so that the channel has a substantially wedge-shape in some cross-sections. For example, FIG. 1H depicts the narrowing of the channel 100i along the axis H-H as depicted in FIG. 1D. In the depicted embodiment the narrowing is a gradual reduction in the width of the channel 100i as it progresses from the first or wide end 100j of the retention channel 100i to the second or narrow end 100k of the retention channel 100i. Similarly, FIG. 1I depicts an embodiment with a narrowing of the channel in the axis I-I as shown on FIG. 1D. Thus, the retention channel 100i in the depicted embodiment narrows in its depth and width as it progresses from first end 100j to second end 100k.

In other embodiments the progression in change in size of the retention channel 100i may be from narrow at the first end 100j to wider at the second end 100k. In yet other embodiments, the change in dimension of the retention channel 100i may be in a stepwise fashion. As can be seen in FIG. 1H, the surface of channel 100i that is closest to inner surface 100h of collar 100a does not change its distance from surface 100h, so only the outer surface of the channel 100i has the gradual narrowing profile. In other embodiments, both sides of the channel 100i may progress inwardly, or the profile shown in FIG. 1H may be reversed.

In the depicted embodiment the retention channel 100i has a substantially T-shaped cross-section as seen in FIGS. 1C and 1D. In other embodiments the cross-section of the channel may be other shapes capable of interlocking with the connecter member 102. For example, the retention channel 100i may have a cross-section in the shape of a cylinder, dovetail, tear-drop, oval, or other similar curvilinear shapes. In some of these embodiments the size of the cross-section of the retention channel 100i may change along the length of the channel, thus creating a conical, frustoconical, truncated conical, or similar three-dimensional volume in the retention channel 100i.

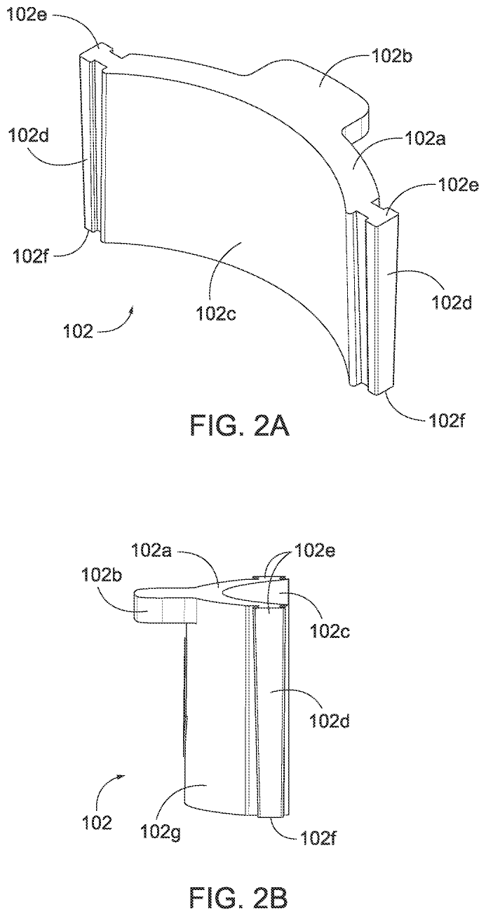

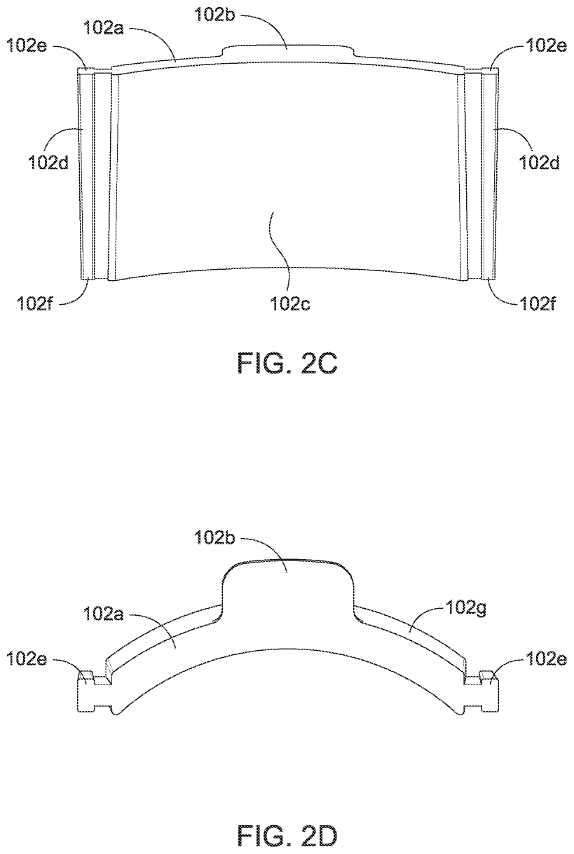

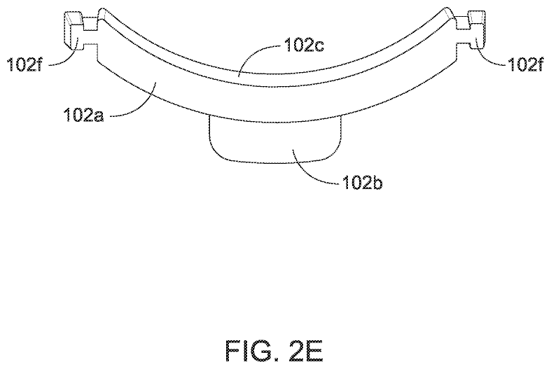

Referring now to FIGS. 2A through 2E, various views of an embodiment of the connector member 102 is depicted. The connector member spans the gap in the collar 100a to complete the bracket around a drainpipe. The depicted embodiment of the connector member 102 has a curved collar portion 102a with a tab 102b on end to allow a user to manipulate the member 102. The collar portion 102a in this embodiment has a curved inner surface 102c that is positioned adjacent to the outer surface of the drainpipe, and a curved outer surface 102g that faces outwardly from the drainpipe. Two opposing ends of the collar member 100a are provided with retention members 102d for engaging the retention channel 100i in flange 100f. In preferred embodiments, the retention members 102d vary in dimension from one end 102e to the other end 102f so that the retention member 102d is held in position when the collar member 102a spans the gap in the collar 100a.

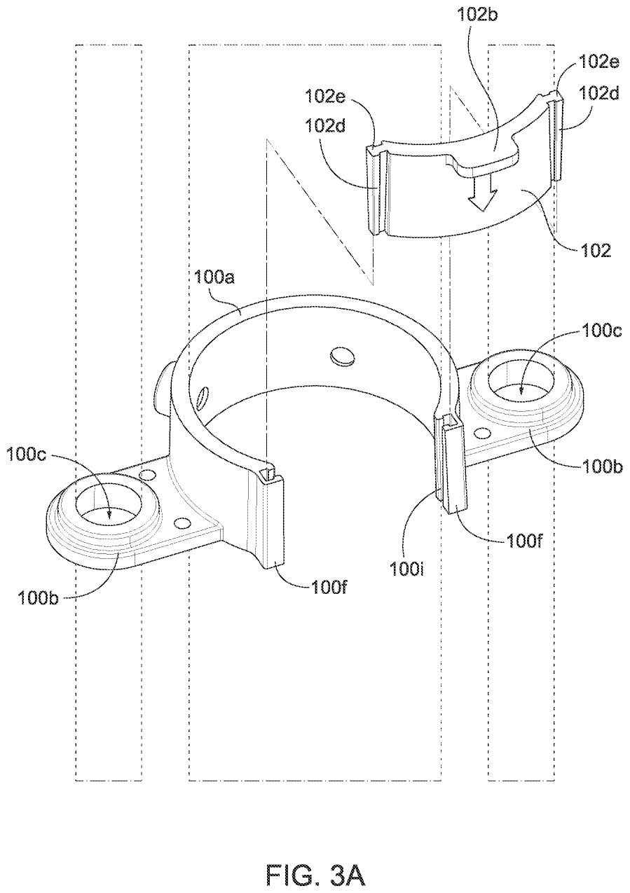

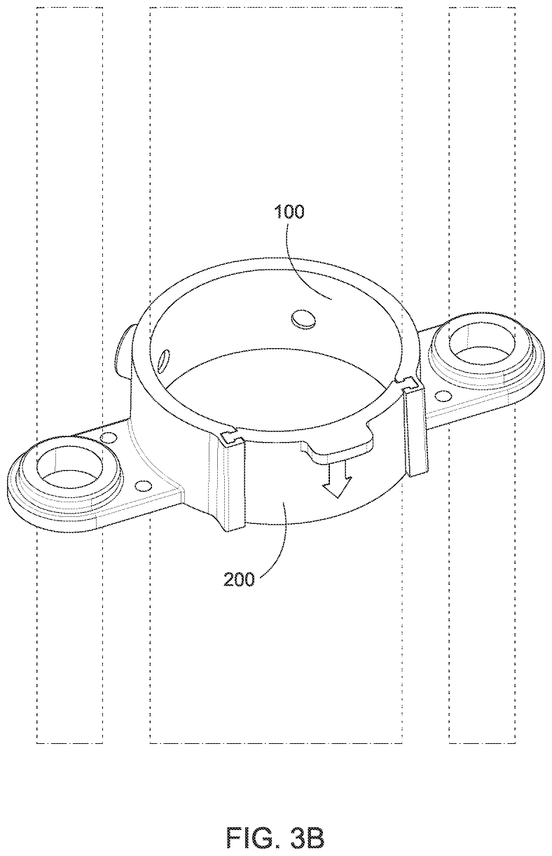

Referring now to FIGS. 3A and 3B, an embodiment of the inventive bracket is shown with the bracket 100 and the connector member 102 attached together. FIG. 3A depicts the connector member 102 in an exploded view, separated from the collar 100. In FIG. 3A, the narrow ends 102e of the retention member 102d will be inserted into the wide ends 100j of the retention channel 100i along the depicted dashed lines. The connector member 100 is then been slid downward so that the retention members 102d are further inside the retention channel 100i.

FIG. 3B shows the final relationship of the bracket 100 and the connector member 102 fully inserted into the gap in the collar 100a. The fixation mechanism may then be secured to hold the pipe in place in relation to the bracket, or vice versa.

“Substantially” or “about” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. A device for attaching water line to a drain pipe, the device comprising a first semi-cylindrical collar member having a gap, a second semi-cylindrical collar member configured to be disposed in the gap in the first collar member, a retention channel on the first collar member for receiving a retention member on the second collar member, and at least one arm having an aperture therein;
wherein the retention channel receives the retention member to hold the second collar member in the gap in the first collar member.

2. The device of claim 1 wherein the retention channel narrows along its length in at least one dimension, and wherein the retention member narrows along its length in the at least one dimension.

3. The device of claim 1 wherein the retention channel and the retention member both narrow in two dimensions along their length.

4. The device of claim 1 wherein the first collar member further comprises a fixation mechanism.

5. The device of claim 1 wherein the retention channel has an inner edge and an outer edge, wherein the inner edge is parallel to the drainpipe and the outer edge is disposed at an angle to the drainpipe.

6. A method of using the device of claim 1 to attach a water line to a drainpipe, comprising the steps of:
passing a mid-portion of the drainpipe through the gap in the first collar,
engaging the retention member of the second collar into the retention channel of the first color,
sliding the second collar into the gap in the second collar, and
inserting a water line into the aperture in the arm.
